(19) United States
(12) Patent Application Publication
(10) Pub. No.: US 2008/0319620 A1
(43) Pub. Date: Dec. 25, 2008

(54) Device For Predictively Determining Gear Ratio Changes in Automatic Transmissions

(75) Inventors: Winfried Fakler, Friedrichshafen (DE); Thomas Voss, Langenargen (DE); Harald Deiss, Ravensburg (DE)

Correspondence Address: DARBY & DARBY P.C., P.O. BOX 770, Church Street Station, New York, NY, 10008-0770, US

(73) Assignee: ZF FRIEDRICHSHAFEN AG, FRIEDRICHSHAFEN (DE)

(21) Appl. No.: 12/064,758

(22) PCT Filed: Aug. 11, 2006
(86) PCT No.: PCT/EP2006/007983

§ 371 Date: Jul. 28, 2008

(30) Foreign Application Priority Data
Aug. 25, 2005 (DE) 10 2005 040 179.1

(51) Int. Cl. G06F 7/00

(52) U.S. Cl. 701/56; 701/51

(57) ABSTRACT

A system for determining a gear ratio change in an automatic transmission of a motor vehicle, includes an electronic control unit, a device for acquiring information about a surroundings of the vehicle, a device for acquiring driver data and/or vehicle data, and a correction module connecting the electronic control unit to the transmission. The correction module is connected to the transmission, to the device for acquiring information about the surroundings, and to the device for acquiring driver data and/or vehicle data. In addition, a method for determining a gear ratio change in an automatic transmission of a motor vehicle using the devices of the system is provided.

This application is a U.S. National Phase application under 35 U.S.C. § 371 of International Application No. PCT/EP2006/007983, filed Aug. 11, 2006, and claims the benefit of German Patent Application No. DE 10 2005 040 179.1, filed Aug. 25, 2005. The International Application was published in German on Mar. 1, 2007 as WO 2007/022888 under PCT Article 21 (2).

The present invention relates to a system for controlling gear ratio changes in automatic transmissions, and it also relates to a method for controlling the gear ratio change.

### BACKGROUND

In vehicles with automatic transmissions, it is a known procedure to allow the gear ratio changes to be determined by electronic control units on the basis of the operating parameters of the vehicle. In addition to the vehicle data, driver data which, for example, reflects the preferences of the driver, are also usually taken into consideration. It is also known to include information about the surroundings in order to determine the gear ratio change. Information from map-based navigation systems as well as sensors of the surroundings can be employed towards this end. Thus, in order to determine the gear ratio change, the current as well as the future driving and environmental situations can be taken into consideration.

German specification DE 195 28 625 shows, for instance, a system for determining the gear ratio change in an automatic transmission in which the gear ratio changes are determined as a function of driver data and vehicle data as well as of route information. In order to determine the route information, a familiar map-based navigation means is integrated into the system for determining the gear ratio change. In this context, the navigation means forwards route information to a device that determines an adaptation variable. This adaptation variable is then forwarded to the adaptive transmission control unit. The gear ratio change is determined in the adaptive transmission control unit, taking into account the adaptation variable. Therefore, an adaptive transmission control unit is modified in such a way that it can take incoming route information into consideration.

### SUMMARY OF THE INVENTION

It is an object of the present invention to provide a device for predictively determining a gear ratio change in automatic transmissions, said device being inexpensive and easy to combine with known transmission control units.

According to the invention, a system for controlling gear ratio changes in automatic transmissions for motor vehicles is being proposed with which an electronic control unit is connected to a device to ascertain driver data and vehicle data. On the basis of this data, the electronic control unit determines a first gear ratio suggestion. This first gear ratio suggestion is forwarded to a correction module located downstream from the electronic control unit, whereby said module either modifies and corrects the first gear ratio suggestion or else forwards it to the transmission without changing it. For this purpose, in addition to vehicle data and driver data, the correction module also receives information about the surroundings which is determined, for example, by map-based navigation means or sensors of the surroundings. Here, the sensors of the surroundings can, for example, measure the distance to a vehicle traveling ahead, read electronic street signs or else process traffic radio information. If this information about the surroundings indicates that the first gear ratio suggestion has to be changed, then the first gear ratio suggestion is corrected and a second gear ratio suggestion is computed on this basis. If no need for a change is recognized, the first gear ratio suggestion is retained and output as the second gear ratio suggestion by the correction module. The second gear ratio suggestion is forwarded to the transmission.

Thanks to the device according to the invention, it is possible to use a prior-art electronic control unit in completely or at least largely unchanged form and only subsequently to consider the information about the surroundings in a second step. Thus, information about the surroundings can be taken into consideration in an existing system for determining gear ratio changes and, as a result, the predictive determination of a driving situation can be implemented, even retroactively.

Here, in a first embodiment, the correction module consists of a device for predictively determining a driving situation as well as of a device for determining the second gear ratio suggestion. A recognized future situation such as, for example, a curve, a long straight segment, an intersection, an uphill road, city or highway driving, or a vehicle driving ahead all constitute driving situations. Depending on the recognized driving situation and on the other incoming vehicle data or driver data, the device for determining the corrected gear ratio suggestion then computes a second gear ratio suggestion. In this context, depending on the recognized driving situation and on the applicable vehicle data or driver data, this second gear ratio suggestion can be the first, unchanged gear ratio suggestion or a modified, new gear ratio suggestion.

In another embodiment, the correction module also comprises a device for determining the preferences of the driver. Here, a recognized preference of the driver is taken into consideration during the determination of the second gear ratio suggestion.

In an advantageous embodiment, the subsequent consideration of the information about the surroundings can also be skipped and the first gear ratio suggestion can also be forwarded directly to the transmission. If the electronic control unit recognizes, for instance, an emergency situation or a malfunction of the correction module, then, as a fallback solution, the first gear ratio suggestion can be forwarded directly to the transmission.

The individual modules of the system according to the invention for determining gear ratio changes can be connected to each other directly via a bus-oriented connection or else wirelessly.

### BRIEF DESCRIPTION OF THE DRAWINGS

In order to better explain the invention as well as its embodiments, a drawing accompanies the description. The drawing shows the following:

FIG. 1—a schematic diagram of the structure of the system; and

FIG. 2—a schematic diagram of the set-up of the correction module.

### DETAILED DESCRIPTION

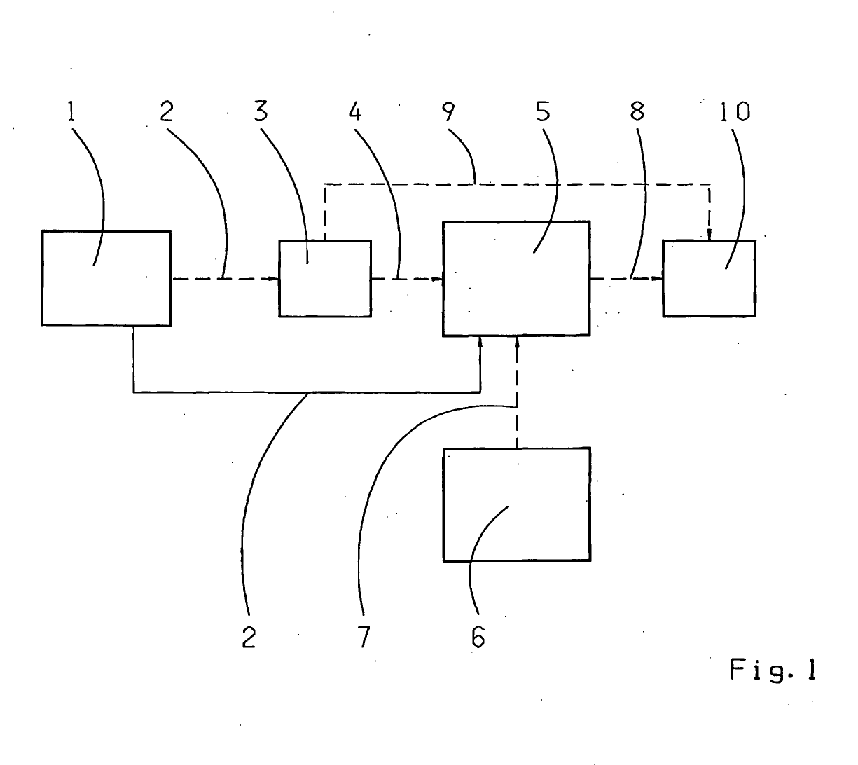

FIG. 1 constitutes a depiction of the structure of a system according to the invention. Here, a device 1 for acquiring driver data and/or vehicle data forwards the recognized driver data and/or vehicle data 2 to an adaptive electronic transmission control unit 3. Vehicle data 2 includes, for instance, the rotational speed curve of the drive, the position of the gas pedal or the vehicle speed. Moreover, a recognized driving behavior of a driver can be forwarded as driver data 2 to the transmission control unit 3. On this basis, the transmission control unit 3 determines a first gear ratio suggestion 4. This first gear ratio suggestion 4 is then forwarded to a predictive or correction module 5. A device 6 for acquiring information about the surroundings forwards the information 7 about the surroundings as well as driver data and/or vehicle data 2 to this correction module 5. The information 7 about the surroundings is recognized either by map-based navigation means or by sensors of the surroundings. On the basis of the incoming information, the correction module 5 determines a second gear ratio suggestion 8. Depending on the incoming information, this suggestion can be the first gear ratio suggestion 4, which is not modified any further, or else can be a new, corrected gear ratio suggestion. Moreover, a direct connection 9 of the transmission control unit 3 to the transmission 10 is shown here as a fallback solution. If the transmission control unit 3 recognizes a malfunction of the correction module 5 or some other emergency situation, the first gear ratio suggestion 4 can also be forwarded directly to the transmission 10. Finally, it is also possible for the electronic control unit to send other signals such as, for example, a prioritizing signal, to the correction module 5.

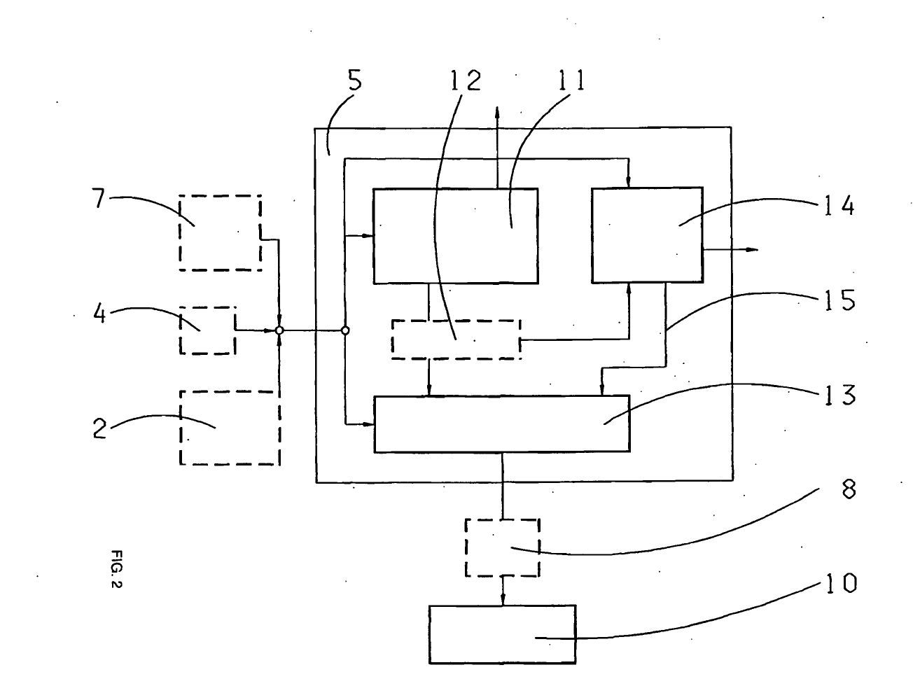

FIG. 2 shows a possible set-up of the correction module 5. Data relating to information 7 about the surroundings, to the first gear ratio suggestion 4 and to the driver data and/or vehicle data 2 is forwarded to the correction module 5. A driving situation module 11 determines a current driving situation 12 on the basis of the incoming data relating to the information 7 about the surroundings. Information about this driving situation 12 is forwarded to the determination module 13, where a second gear ratio suggestion 8 is determined. At least the driver data and/or vehicle data 2 is also transmitted to the determination module 13. The data relating to the current driving situation 12 is also sent to an optionally present driver preference module 14 that also contains the driver data and/or vehicle data 2. This is where a driver preference 15 is recognized that is then forwarded to the determination module 13. The correction module 5 then outputs at least a second gear ratio suggestion 8 and can optionally also output information about the currently recognized driving situation 12 or the driver preference 15.

1-12. (canceled)

13. A system for determining a gear ratio change in an automatic transmission of a motor vehicle, comprising:
an electronic control unit;
a device for acquiring information about a surroundings of the vehicle;
a device for acquiring driver data and/or vehicle data;
a correction module connecting the electronic control unit to the transmission, the correction module connected to the transmission, to the device for acquiring information about the surroundings, and to the device for acquiring driver data and/or vehicle data.

14. The system as recited in claim 13, wherein the electronic control unit is configured to feed a first gear ratio suggestion to the correction module, wherein the correction module is configured to receive information about the surroundings from the device for acquiring information and to receive driver data and/or vehicle data from the device for acquiring driver data and/or vehicle data, and wherein the correction module is configured to forward a second gear ratio suggestion to the transmission.

15. The system as recited in claim 13, wherein the correction module includes a driving situation module configured to determine a future and/or current driving situation and a determination module configured to determine the second gear ratio suggestion.

16. The system as recited in claim 15, wherein the information about the surroundings, the first gear ratio suggestion and the driver data and/or vehicle data can be forwarded to the correction module, wherein the driving situation module is configured to forward data relating to a future and/or current driving situation to the determination module and wherein the determination module is configured to forward the second gear ratio suggestion to the transmission.

17. The system as recited in claim 15, wherein the correction module includes a driver preference module configured to recognize a driver preference and connected to the driving situation module and to the determination module.

18. The system as recited in claim 17, wherein the driving situation module is configured to forward data relating to the future and/or current driving situation to the driver preference module and wherein the driver preference module is configured to forward data relating to the driver preference to the determination module.

19. The system as recited in claim 13, wherein the electronic control unit is directly connectable to the transmission upon recognition of a malfunction.

20. The system as recited in claim 17, further comprising a bus-oriented connection connecting at least two of the device for acquiring driver data and/or vehicle data, the electronic control unit, the correction module, the device for acquiring information about the surroundings, the transmission, the driving situation module, the determination module, and the driver preference module.

21. The system as recited in claim 17, wherein at least two of the device for acquiring driver data and/or vehicle data, the electronic control unit, the correction module, the device for acquiring information about the surroundings, the transmission, the driving situation module, the determination module, and the driver preference module are connected wirelessly.

22. The system as recited in claim 21, wherein the at least two devices are connected by at least one of inductively and by radio.

23. A method for determining a gear ratio change in an automatic transmission of a motor vehicle, the method comprising:
feeding driver data and/or vehicle data to an electronic control unit;
determining a first gear ratio suggestion using the electronic control unit based on the driver data and/or vehicle data;
feeding the first gear ratio suggestion to a correction module disposed downstream of the electronic control unit;
receiving data relating to information about the surroundings and driver data and/or vehicle data into the correction module;
creating a second gear ratio suggestion using the correction module by either modifying or retaining the first gear ratio suggestion as a function of the incoming data; and
forwarding the second gear ratio suggestion to the transmission.

24. The method as recited in claim 23, further comprising:
determining a future driving situation in the driving situation module based on the information about the surroundings; and
forwarding the future driving situation to at least one of the determination module and the driver preference module.

25. The method as recited in claim 24, wherein the correction module includes a determination module and wherein the second gear ratio suggestion is computed by the determination module as a function of the recognized driving situation.
